(19) United States
(12) Patent Application Publication
(10) Pub. No.: US 2014/0108171 A1
(43) Pub. Date: Apr. 17, 2014

(54) CERTIFICATION OF ORIGIN

(71) Applicant: NagraID S.A., La Chaux-de-Fonds (CH)

(72) Inventor: Patrick Bernheim, Estavayer-le-Lac (CH)

(21) Appl. No.: 13/650,677

(22) Filed: Oct. 12, 2012

(51) Int. Cl. G06Q 20/38; G06Q 20/20

(52) U.S. Cl. CPC G06Q 20/38; G06Q 20/20
USPC 705/17

(57) ABSTRACT

This invention relates to a system of certification of origin of a consumer good, the system comprising a bank payment network (4), a point of entry terminal (E1), a bank payment network element (B1) and a verification element (G1). The network element (B1) is configured to issue an authentication medium (D1) to be sent to the point of entry terminal (E1), the authentication medium (D1) containing an identification number. The point of entry terminal (E1) is configured to extract or capture the identification number from the authentication medium (D1) at the time of a request for certification of the origin of a consumer good, and to transmit the request for certification of origin with the identification number via the bank network to the network element (B1), which is configured to transfer the identification element to the verification element (G1) arranged to verify the origin of the good.

### FIELD OF THE INVENTION

The present invention relates to a system of certification of origin of various products or consumer goods, for example watches, leather goods, or wines, for instance, and in particular luxury goods, essentially high value-added products, sold by distributors and specially authorized merchants. The invention also relates to a method for carrying out a certification of origin of a consumer good in said system. The present invention also relates to an authentication medium used in said system and a device for carrying out the certification of origin.

### DESCRIPTION OF THE PRIOR ART

Currently, the sector for luxury goods, of all kinds, is constantly developing. Demand is growing regularly every year, and the emergence of certain countries further accentuates this phenomenon. The large sums of money which this represents arouse the keen interest of a population of infringers or other “pirates”.

The problem with this growing demand is to ensure the circulation of the consumer goods within the best time limits and with the best security conditions anywhere on the globe and to ensure the origin in keeping with the expectations of the final customer. It is also a matter of complying with so many different and complex laws and taxes from one country to another. At the present time the documents are made by hand, sometimes in electronic form. Such a report can be sent by post, by e-mail or through an Internet site with all the risks which that entails. However, this makes an efficient and comprehensive management difficult. The different actors in this network must do a certain amount of work which requires time, technical knowledge and diligence. Automatic and computerized management of a system of certification of origin for consumer goods poses today a real problem. In particular, the distributors or their employees do not always have access to a computer in their shops or to information which is often confidential and protected.

The existence of a “grey market”, of alternative routing of spare parts and consumer goods, are likewise just as much holes in the distribution networks and represent large sums of lost money for all the players in this network.

### SUMMARY OF THE INVENTION

The present invention has as its object to resolve the above-mentioned problems by proposing a system of certification of origin of consumer goods which is efficient and is easy to use for the merchants who sell these consumer goods. In particular, the present invention has as its object to propose such a system which is operational on the international level and which does not limit the number of merchants able to use it.

To this end, the first aspect of the present invention has as subject matter a system of certification of origin of a product, the system comprising a bank payment network, a point of entry terminal, an element of the bank payment network and a verification element, wherein
the element of the bank payment network is configured to issue an authentication medium to be sent to the point of entry terminal, the authentication medium containing an identification number, the format of which is compatible with that accepted by the bank payment network;
the point of entry terminal is configured to extract or capture the identification number from the authentication medium at the time of a request for certification of origin of a product, and to transmit the request for certification of origin with the identification number to the bank payment network;
the verification element is configured to keep in a memory the identification number issued by the element of the bank payment network or a reference to this identification number, to receive the identification number or a reference to this identification number linked to the request for certification of origin, and to verify the origin of the product the certification of origin of which has been requested by verifying whether the identification number or the reference to this identification number received, which is linked to the request for certification of origin, is located in the memory.

Thus, thanks to the present invention, an efficient and relatively simple system is obtained for carrying out a certification of origin of a consumer good by using a banking network. The first element can in fact be a single physical element or it can be made up of at least two physical elements. As all the authentication documents are identified, upon their use, and owing to the data received from the banking network, the information exchanged makes it possible to locate very precisely the exact place of the sale.

A second aspect of the present invention has as subject matter a method for certifying the origin of a product in a system comprising a bank payment network, a point of entry terminal, an element of the bank payment network and a verification element, comprising
the issuing by the element of the bank payment network of an authentication medium to be sent to the point of entry terminal, the authentication medium containing an identification number the format of which is compatible with that accepted by the bank payment network;
the extraction or capturing by the point of entry terminal of the identification number from the authentication medium at the time of a request for certification of origin of a product;
the transmission of the request for certification of origin with the identification number to the bank payment network;
the keeping by the verification element, in a memory, of the identification number issued by the element of the bank payment network or a reference to this identification number;
the receiving by the verification element of the identification number or a reference to this identification number connected to the request for certification of origin; and
the verification of the origin of the product, for which the certification of origin has been requested, by verifying whether the received identification number or the received reference to this identification number, which is connected to the request for certification of origin, is located in the memory.

A third aspect of the present invention has as subject matter a device for the certification of origin of a product, the device having means to connect itself to a bank payment network, the device having means for:
issuing an authentication medium to be sent to a point of entry terminal, the authentication medium containing an identification number, the format of which is compatible with that accepted by the bank payment network;
keeping in a memory the identification number created in the
receiving from the point of entry terminal via the bank payment network the identification number extracted or captured by the point of entry terminal at the time of a request for certification of origin; and
verifying the origin of the product for which the certification of origin has been requested by verifying whether the number of the identification number received from the point of entry terminal is located in the memory.

The other aspects of the present invention are found in the dependent claims.

### BRIEF DESCRIPTION OF THE DRAWINGS

The invention will be well understood from reading the following description, given by way of non-limiting example, with reference to the attached drawing which represents schematically:

FIG. 1 illustrates in a diagrammatic way the system of certification of origin of a consumer good according to one example of the present invention.

### DETAILED DESCRIPTION OF EMBODIMENTS

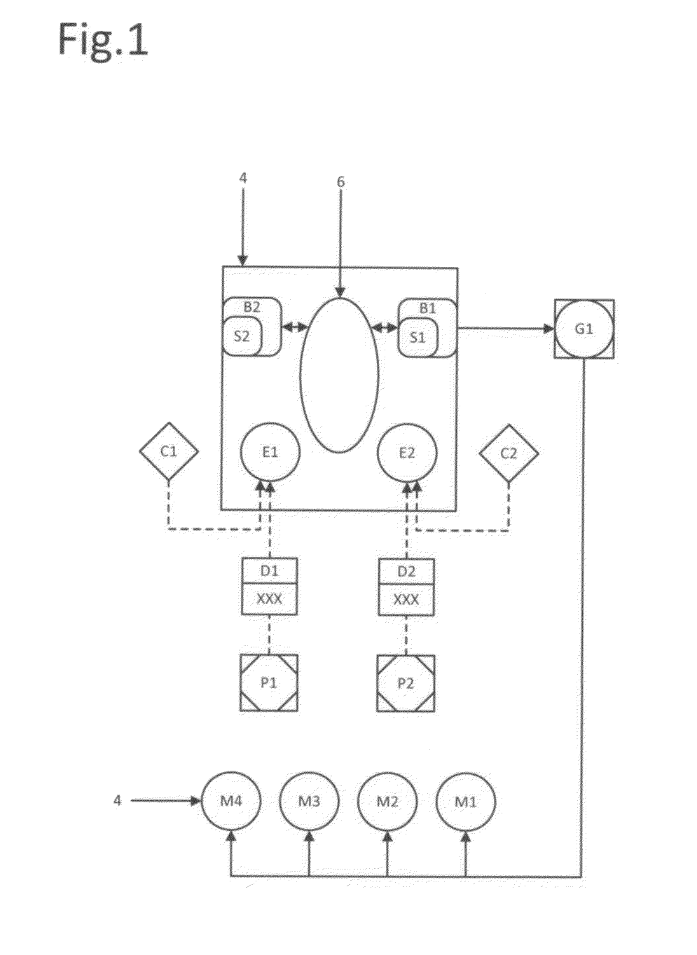

Referring to FIG. 1, one non-limiting embodiment of the system and of the corresponding method according to the present invention is now explained in more detail.

In a more detailed fashion, a method for carrying out a certification of origin of a consumer good according to an exemplary embodiment according to the present invention comprises the following steps:
A) issuing of an authentication medium, which could also be called a certification medium, by a first partner of a bank payment network, this authentication medium containing an identification number, also called “personal identification number (PIN)” or “unique identification number (UID)”, the format(s) of which is/are compatible with that or those accepted by the bank payment network;
B) storing of the created identification number in a memory at an element which keeps a table or a list of identification numbers;
C) transmitting of the authentication medium to the receiver, which can be a merchant, a seller, a buyer, customs, a control organ or any other entity that wants to request a certification of origin;
D) sending of the consumer good to the entity that wants to make a request for certification of origin;
E) at the time of the request for certification of origin, transmitting of the identification number to an information processing system of the first partner, via the bank payment network, this transmission having taken place from a point of entry of this bank payment network to which the requester has access;
F) receiving by the first partner, via the bank network, of the identification number and possibly collecting data connected with the sale;
G) registering, through the information processing system of the first partner, of the fact of receipt of this identification number;
H) after receipt of the identification number by the first partner, communicating this identification number or a reference to the consumer good concerned, possibly with other data concerning the sale, to the element that keeps the above-mentioned table;
I) verifying the origin of the consumer good under consideration by consulting the table;
J) sending a confirmation of the origin to the requester; and
K) printing by the requester of a certificate of origin.

In a more general way, the information is transmitted, by a double flux, to the element which keeps the table and to the receiver who is thus the requester of the certification of origin in order to guarantee the origin of the consumer good through return of explicit or encrypted information. Each of the consumer goods is linked to one or more unique identification number(s), hidden or not by a specific method. One can also have a unique identification number for a plurality of consumer goods, constituting, for example, a combination of products. This identification number is printed on a medium of bank card type, wherein this identification number is registered, the format(s) of which is/are compatible with that or those accepted by the bank payment network.

Generally, but not necessarily, the identification number of the authentication medium itself suitable for the certification of origin is different from the reference for the product used by the manufacturer or the distributor of the product. A look-up table can also be provided, which can be created, for example, by the first partner or by the manufacturer of the good, or by another element, allowing a link to be made between the identification number and the product reference. This look-up table can be located with the transaction operator or can be introduced directly in the information processing system of the first partner, i.e. the issuer of the authentication media or supplier of the consumer goods. Thus the final link will be made between the consumer good and the identification number.

Understood by bank payment network is a national or international network installed at the merchants who sell the consumer goods under consideration in order to enable their clients to carry out bank payments at the time of purchase of these goods. By way of example only, the bank payment network is the international network managed by the companies American Express, MasterCard, or VISA (registered trademarks). This network makes it possible for us to communicate all the elements of geolocation and of tracking of the sale of the consumer good.

The merchants all take part in a given distribution network and are very precisely identified. Their connection to the bank payment network makes possible geographic localization. In certain cases, the merchant is not identified because he is outside the official distribution network or his area is too large to carry out a simple geolocalization. In this particular case, it is then proposed according to the invention to add a supplementary step in order to refine the localization. This step comprises the use of a testimony card prior to the transaction connected with the sale which makes it possible to situate precisely the merchants in the network.

The testimony card is sent to the merchant by the administrator of the distribution network before dispatch of the consumer good. An exchange of information by double flux makes it possible to find out exactly the location and to expand the database. More precisely, when the seller is not in the official distribution network, he receives, to start with, a testimony card, for one-time use, which he must use the first time in his electronic payment terminal (EPT). An exchange of information between the two parties (administrator of the network and point of sale) makes it possible to learn with precision the localization of the point of sale and to validate the authorized point of sale. This operation is likewise used to localize the different EPTs which are situated in a large area or a multi-storey point of sale. Thus this allows the localization to be improved and refined.

The present invention also allows a geographic identification of the point of sale to be carried out or a tracking of the sale to be carried out. In a general way, the geographic identification is made through use of the bank payment network. With each transaction on the electronic payment terminal (which is thus the point of entry), the data relating to the device (EPT) and/or to the merchant are sent over the network and are checked by the bank processor. These data are, for example, the code of the country and/or the code of the city where the transaction has been made, the code for the transaction, the amount, the time, etc. It should be noted that the merchant always controls his EPT with his local bank and that the bank processor carries out all the operations of identification and of checking. It expands its database using these data. All these data are available on the bank payment network and make it possible to geolocate the point of sale and to carry out a tracking of the sale.

Understood in a general way by merchant, actor in the distribution or distribution operator is a store or shop, any point of sale, a boutique, a stand at a fair, and any entity able to carry out sales of consumer goods. The merchant can be a natural person or a company. In the case of a company, the employees authorized to collect the money from the customers are equated with the merchant. According to the terms used to describe a payment network of the VISA or MasterCard type, the bank of the merchant is called the receiver because it is the one that receives the amount of the sale on a bank account of the merchant via the bank payment network. The merchant can receive in return the data of the tracking of the sale for the party it concerns. Thus a tracking is maintained in the form of confirmation.

Understood by authentication medium is any medium able to be printed on and/or able to be provided with a magnetic strip and/or incorporated into an electronic unit, such as a chip, linked to communication means. These communication means can be resistive or contactless, for example an antenna. This medium can be a sheet of paper, a plastic card, a product package or the product itself. The plastic card is, for example, an electronic card of common banking format. In particular in the case of a medium incorporating an electronic unit managing the geographic identification application and the application of authentication of the sales operations, and in which the identification number is recorded, and an antenna or an emitter connected with this electronic unit in order to communicate with a contactless electronic payment terminal (equipped with RF or infrared communication means, for example), the authentication medium can be a paper document, an electronic label or an electronic card or plate of any form or any other object of transponder type. This medium can also be a portable telephone or another electronic device of the merchant equipped with communication means for receiving from an administrator of a distribution service or from companies using the trademarks for the products concerned the identification numbers of these products that are provided to the merchant. This portable telephone or other electronic device is preferably equipped with means of communication with an EPT. In a special embodiment, the authentication medium consists of a single magnetic strip disposed on the consumer good or its packaging. In another special embodiment, the authentication medium consists only of an electronic unit and its communication device, notably an antenna, and it is incorporated in the product itself or in its packaging, the product or its packaging serving then as medium.

Understood by point of entry in the bank payment network is preferably an electronic payment terminal of this network installed at a point of sale of the merchant. In another variant, the point of entry in the payment network can consist of an Internet site giving access to this network via a secured interface in which at least the identification number of the good sold is entered in the same way as a VISA or MasterCard card number, but in order to activate the certification of origin of this good. It will be noted that any point of entry accepted by the bank payment network can be used to the extent that this point of entry allows the certification of origin of a good to be requested.

Understood by partner of the bank payment network is notably the banks and other financial organizations that administrate bank accounts and which are members or partners of this network. The partner of the bank payment network, who issues the identification numbers of the consumer goods under consideration, these identification numbers having a format compatible with this network, is also called the issuer.

In the case of a bank payment network, the issuer generally issues bank cards containing a card number in the format of the network for making bank transactions. The card is generally issued in the name of a natural person or legal entity (the client of the issuer) who is called the bearer because he or she possesses the card and disposes of it. At the time of a payment, the buyer generally carries the bank card on him. Within the framework of the present invention, the client of the issuer is the administrator of the distribution service. This administrator of the distribution service is not a bearer of the bank card in the sense of the conventional payment network. In fact, it is possible in certain cases that this administrator never has the issued authentication medium or more generally the issued authentication medium with the identification number provided for the certification of origin. The bearer changes in the course of time following the issue of the authentication medium up until the sale of the related product. Initially, the authentication media can be issued to the administrator of the distribution service or directly to a production unit for the product concerned or also, for example, to a company that makes the packaging for the product or that carries out the distribution. Then the authentication medium follows the product until it is with the merchant who then becomes the custodian of this authentication medium until the sale of the product. After the sale, the authentication medium generally returns to the customer of the merchant having acquired the product, after the certification of origin has been carried out according to the invention.

In its simple way of working, the identification number is printed on the authentication medium and possibly hidden in such a way that the first layer must be scratched in order for it to appear (“scratch-off”). The fact that the identification number is hidden has the aim of increasing the security of the system. As the identification number is also encoded in the magnetic strip of the authentication medium, this information is read by the EPT; finally the identification number can also be captured on the keyboard of the EPT. Depending upon the application concerned, it can also suffice for the identification number to be given manually on the EPT. Once the EPT knows the identification number, it sends it to the first partner via the bank payment network. As explained further above, the verification of origin of the consumer good is achieved by the element that keeps the table or the list containing the issued identification numbers. In other words, this element consults the table, and if the identification number it has just received is found in this table, it can thereby guarantee the origin. If this identification number is not found in the table, no verification of origin can be given. Thus this element that keeps the table carries out a “matching” in this table. In this way, the certification of origin can be ensured.

In another variant, the authentication medium is located directly in the consumer good. As previously mentioned, the identification number is to be captured on the EPT. The “matching” is carried out in the same way as described further above.

There exists another variant in the method, according to which the bank operator blocks beforehand an UID series of numbering. This range of numbering is hosted and secured in such a way that the “matching” is done directly by the administrator of the bank payment network. Thus the certification of origin is guaranteed in a more secured environment.

A concrete case according to one embodiment of the present invention will be described in the following, in particular with the aid of FIG. 1, given by way of absolutely non-limiting example, which represents schematically a bank payment network used according to the invention for the certification of origin of consumer goods.

Represented in this FIG. 1 is a system 2 of certification or verification of origin of consumer goods or products P1 and P2. The consumer goods are sold by merchants C1 and C2, the number of merchants not being limited. This system of certification of origin is made up of a bank payment network 4 and each of the products P1, P2 is linked to an authentication medium D1, respectively D2, on which is written or wherein is recorded an identification number (XXX), the format(s) of which is/are compatible with that or those accepted by said bank payment network. The authentication medium is made up in this preferred example of an electronic card. The card D1 has an electronic unit whereas the card D2 has only a magnetic strip.

The request for the certificate of origin for any one of the products can be made from a point of entry E1 or E2 of the bank payment network to which the requester C1, respectively C2, has access, who in this example is a merchant who sells the consumer good under consideration. In the embodiment shown in FIG. 1, the point of access E1 is constituted by a EPT and the point of access D2<sic. E2> is made up of the secured interface on a website shown by a computer, this website belonging to the network 4 and being linked to the system 6 for processing and for communication of data relating to transactions made through the bank payment network. It will be noted that the secured interface can, in a variant, be directly connected to the system 6 without passing through the Internet. The EPT E1 is configured to read the identification number in recorded banking format in the electronic unit of the electronic card D1. In a variant (not shown), the point of access E1 is configured to read the magnetic strip on the card D. For the point of access E2, it is necessary to enter the identification number XXX on the page of the secured interface provided for this purpose. Therefore this number is written on the card D2. Other types of points of entry can be foreseen, in particular a server or a network telephone service 4 which is accessible through a call line, in particular by means of a portable telephone.

During the method, the bank payment network 4 is configured to transmit, from the point of entry E1 or E2, at least the identification number XXX of the product P1 or P2 to the information processing system S1 of a first partner of this network 4, the bank B1, which has issued this identification number for a holder G1. The information processing system S1 of this first partner records the fact of an identification number having been transmitted to it. The information processing system S1 of a first partner can also receive from the bank payment network 4 the data (the date, the time, the amount, the country, and/or the city, etc.) relating to the sale. These data can be received at the same time as the identification number.

In the example of FIG. 1, the holder G1 is, for example, a company commissioned by various companies owning trademarks M1, M2, M3 and M4. One could also call “holder” the certification service or a verification element or an administrator of the distribution service. After reading of the card, the holder G1 receives from the issuer at least the identification numbers relating to the guarantee cards or warranty cards activated in relation to this account or it receives the references for the consumer goods corresponding to these identification numbers.

Thus, the information processing system of the first partner B1 communicates to the holder G1 the identification numbers received, or, for a received identification number, a reference (for example model reference, series number or piece number) for the consumer good corresponding to this identification number. In fact, in general, the identification number of the authentication medium itself is different from the product reference used by the manufacturer or the distributor of the product. To make a link between a specific product and the identification number, a look-up table can be provided allowing a link to be made between the identification number and the product reference. This look-up table in this example is located with the holder G1, but it could be introduced directly into the information processing system of the first partner, i.e. the issuer of the authentication media, in such a way that the holder G1 or his clients receive directly the references for the products from the issuer for the corresponding identification numbers that he has received.

FIG. 1 mentions furthermore another partner B2, having his own information processing system S2, who can act as an issuer for another holder and/or as a receiver for another merchant.

According to this example, the transmission of the identification number by the bank payment network 4 is carried out at the time of a request for certification of origin of a consumer good by sending this request from the point of entry E1 or E2 to the first partner B1 (or B2). After receipt of this request, the first partner B1 transfers the request to the holder G1 who carries out the verification of origin by consulting the table that he keeps. If the identification number received from the requester C1, possibly via the first partner B1, is found in the table, the origin of the product concerned can thus be certified. In the case where the identification number is not found in the table, the certification of origin cannot be confirmed. It is also possible that the requester C1 sends the identification number directly to the holder G1. In all cases a tag can be included in the request for certification of origin sent by the requester C1 to indicate that the identification number comes from the requester.

Generally, in the case where the origin is verified for the good under consideration, it is foreseen in this example that the holder G1, possibly via the first partner B1, confirms the origin of the good through a message sent specifically to the point of entry.

The point of entry can be connected to a printing unit configured to print a receipt for the confirmation of origin of the good. The response by double flux is thus activated.

According to a general variant, an identifier for the requester C1 or C2 is also transmitted to the information processing system S1 of the first partner B1 together with, or without, the transmission of an identification number by this requester. Consequently, the information processing system S1 of the first partner B1 can verify whether the requester is authorized to carry out the request for the consumer good under consideration.

In a variant, the certification of origin for the consumer good under consideration is made only if the requester is authorized.

In another variant, in the case where the merchant is not authorized to make the request for the consumer good under consideration, the information processing system S1 of the first partner B1 records the receipt of the identification number and communicates this fact to the holder G1.

In another variant, in the case where the requester is not authorized to make the request, the information processing system S1 of the first partner B1 indicates this to the point of entry.

According to a general variant, the information processing system S1 of the first partner B1 verifies whether the certification of origin of the consumer good linked to the identification number has not been prohibited. In particular, in the case where the certification of origin of the consumer good under consideration has been prohibited, the information processing system S1 of the first partner indicates this to the point of entry.

According to a specific variant, in the case where the certification of origin of the consumer good under consideration has been prohibited, the information processing system S1 of the first partner communicates to the holder G1 the receipt of the identification number for this consumer good.

The authentication medium can be provided with an expiration date for the certification of origin, in particular for products which require maintenance, such as a mechanical watch. In the case of an electronic document, the expiration date can be recorded in the authentication medium, and the electronic payment terminal verifies whether this date has passed or not before initiating a request for certification of origin. It will be noted that this expiration date can also be recorded in the information processing system of the issuer, who does not agree to process <sic. who agrees not to process> a request for certification of origin if this expiration date has passed. In this case, the requester C1 would, for example, have to return the product for a check or maintenance service and he would receive a new authentication medium or the expiration date would be reprogrammed in the electronic authentication medium.

According to a general variant, no information linked to the holder G1 can be learned from the identification number linked to an authentication medium or other data circulating in the bank payment network in relation to the certification of origin of the corresponding good, the identity of this holder being known only from the first partner B1 in this system.

According to an example, the authentication medium is made up of a card of banking type D1 or D2. The point of entry of the bank payment network is here an EPT installed at the requester and adapted to read the magnetic strip or the electronic unit of the card.

The authentication medium used in the method of the invention, in particular a card D1, D2, contains an identification number XXX have a format or formats compatible with that or those accepted by a bank payment network 4. According to the invention, this authentication medium is issued by a partner (issuer of the authentication medium) of the bank payment network.

Several variations can also be envisaged in the configuration explained above without going beyond the scope of the present invention.

1. A system of certification of origin of a product, the system comprising a bank payment network, a point of entry terminal, an element of the bank payment network and a verification element, wherein
the element of the bank payment network is configured to issue an authentication medium to be sent to the point of entry terminal, the authentication medium containing an identification number, the format of which is compatible with that accepted by the bank payment network;
the point of entry terminal is configured to extract or capture the identification number from the authentication medium at the time of a request for certification of origin of a product, and to transmit the request for certification of origin with the identification number to the bank payment network;
the verification element is configured to keep in a memory the identification number issued by the element of the bank payment network or a reference to this identification number, to receive the identification number or a reference to this identification number linked to the request for certification of origin, and to verify the origin of the product the certification of origin of which has been requested by verifying whether the identification number or the reference to this identification number received, which is linked to the request for certification of origin, is located in the memory.

2. The system according to claim 1, wherein the element of the bank payment network is furthermore configured to receive from the point of entry terminal the identification number extracted or captured at the time of the request for certification of origin and is configured to communicate to the verification element the identification number received, or, for a received identification number, a reference to this identification number.

3. The system according to claim 1, wherein the verification element is configured to send a confirmation of the certification of origin intended for the point of entry terminal if the identification number or the reference to this identification number received, which is linked to the request for certification of origin, is located in the memory.

4. The system according to claim 1, wherein the point of entry terminal is connected to a printing unit for printing a receipt for the confirmation of the certification of origin.

5. The system according to claim 1, wherein the point of entry is furthermore configured to transmit an identifier for the requester for the certification of origin to the element of the bank payment network or to the verification element.

6. The system according to claim 5, wherein, after having received the identifier for the requester, the element of the bank payment network or the verification element is configured to verify whether the requester is authorized to make the request for the certification of origin of the product concerned.

7. The system according to claim 6, wherein the certification for the product concerned is configured to be activated only if the merchant is authorized.

8. The system according to claim 7, wherein, in the case where the requester is not authorized to carry out the certification of the product concerned, the element of the bank payment network is furthermore configured to record the receipt of the identification number and to communicate this fact to the verification element.

9. The system according to claim 1, wherein the element of the bank payment network or the verification element is furthermore configured to verify whether the request for the certification of origin of the product connected with the identification number or with the reference to this identification number has not been prohibited.

10. The system according to claim 9, wherein, in the case where the request for authorization of the certification of origin of the product concerned has been prohibited, the element of the bank payment network or the verification element is furthermore configured to inform the point of entry about this.

11. The system according to claim 1, wherein no information connected to the verification element can be learned from the identification number or from other data circulating in the bank payment network relating to the request for the certification of origin, the identity of the verification element being known only from the element of the bank payment network.

12. The system according to claim 1, wherein the authentication medium is made up of a card of banking type.

13. The system according to claim 1, wherein the identification number is printed on this authentication medium, but is hidden by a “scratch-off” process.

14. The system according to claim 1, wherein the authentication medium has a magnetic strip in which the identification number is recorded and/or an electronic unit in which the identification number is recorded.

15. The system according to claim 1, wherein the point of entry is an electronic payment terminal installed at the requester and adapted for reading the authentication medium.

16. The system according to claim 1, wherein the element of the bank payment network comprises the verification element.

17. A method for certifying the origin of a product in a system comprising a bank payment network, a point of entry terminal, an element of the bank payment network and a verification element, comprising
the issuing by the element of the bank payment network of an authentication medium to be sent to the point of entry terminal, the authentication medium containing an identification number, the format of which is compatible with that accepted by the bank payment network;
the extraction or capturing by the point of entry terminal of the identification number from the authentication medium at the time of a request for certification of origin of a product;
the transmission of the request for certification of origin with the identification number to the bank payment network;
the keeping by the verification element, in a memory, of the identification number issued by the element of the bank payment network or a reference to this identification number;
the receiving by the verification element of the identification number or a reference to this identification number connected to the request for certification of origin; and
the verification of the origin of the product, for which the certification of origin has been requested, by verifying whether the received identification number or the received reference to this identification number, which is connected to the request for certification of origin, is located in the memory.

18. A device for the certification of origin of a product, the device having means to connect itself to a bank payment network, the device having means for:
issuing an authentication medium to be sent to a point of entry terminal, the authentication medium containing an identification number, the format of which is compatible with that accepted by the bank payment network;
keeping in a memory the identification number created in the previous step;
receiving from the point of entry terminal via the bank payment network the identification number extracted or captured by the point of entry terminal at the time of a request for certification of origin; and
verifying the origin of the product for which the certification of origin has been requested by verifying whether the number of the identification number received from the point of entry terminal is located in the memory.
